(19) United States
(12) Patent Application Publication
(10) Pub. No.: US 2013/0221208 A1
(43) Pub. Date: Aug. 29, 2013

(54) PHOTOELECTRIC BARRIER

(71) Applicants: Bernd Ottleben, Bad Salzdetfurth (DE); Petra Ottleben, Bad Salzdetfurth (DE)

(72) Inventors: Bernd Ottleben, Bad Salzdetfurth (DE); Petra Ottleben, Bad Salzdetfurth (DE)

(73) Assignee: PANTRON INSTRUMENTS GmbH, Bad Salzdetfurth (DE)

(21) Appl. No.: 13/821,337

(22) PCT Filed: Aug. 31, 2011
(86) PCT No.: PCT/DE2011/001670

§ 371 Date: May 17, 2013

(30) Foreign Application Priority Data
Sep. 8, 2010 (DE) 10 2010 044 730.7

(51) Int. Cl. G01V 8/14

(52) U.S. Cl. CPC G01V 8/14
USPC 250/221

(57) ABSTRACT

The invention relates to a photoelectric barrier with a transmission device (2) for the transmission of a beam of electromagnetic radiation along a first path (6), a diverter for diverting the transmitted beam of electromagnetic radiation from the first path (6) onto a second path (12), and a reception device (16) for receiving the beam of electromagnetic radiation, characterized by the fact that the diverter is designed for a diversion that retains the beam's constellation relative to a plane containing the first path (6) and the second path (12).

The invention refers to a photoelectric barrier with a transmission device for the transmission of a beam of electromagnetic radiation along a first path, a diverter for diverting the transmitted beam of electromagnetic radiation from the first path onto a second path and a reception device for receiving the beam of electromagnetic radiation.

These types of photoelectric barrier are used in order to monitor whether there is an obstacle in an area or not. In order to be able to monitor as large an area as possible, a bundle of electromagnetic beams transmitted along the first path, for example an infra-red beam, is diverted via two mirrors and transferred along the second path. This second path often runs parallel to the first path and is only offset by a certain distance relative to this. If this distance corresponds to the lateral dimensions of the transmitted bundle of beams, the two bundles of beams on the first path and the second path directly adjoin each other, so that the area which can be monitored by the photoelectric barrier corresponds to twice the diameter of the bundle of beams.

In order to trigger the switching operation controlled by the photoelectric barrier, the shape of the object in the beam path of the photoelectric barrier is generally not important. Therefore, in most cases it is sufficient if the reception device is only detecting the intensity or radiated power of the light falling on it. As soon as the power falls below a predefined value, it is assumed that there is an obstacle in the beam path, triggering the switching operation controlled by the photoelectric barrier. The loss of intensity on the reception device naturally depends on the size of the object in the beam path of the photoelectric barrier. With objects that are too small, it is possible that the loss of intensity on the reception device is too low to trigger the switching operation.

It is also a disadvantage that, with a conventional photoelectric barrier, the loss of intensity on the reception device caused by an object in the beam path also depends on where the object is located in the beam path, especially at which point it is perpendicular to the direction of propagation of the bundle of beams.

In particular, the detection sensitivity of the photoelectric barrier for objects which are located exactly in the middle of the monitored area, i.e. which obstruct the transmitted bundle of beams partially on the first path and the rest on the second path, is especially low.

The present invention thus aims to propose a photoelectric barrier with which the detection sensitivity is improved.

The invention solves the task at hand through the design of the diverter, which is made for a diversion that retains the beam's constellation relative to a plane containing the first path and the second path. It is advantageous if the electromagnetic beam which can be transmitted by the transmission device is a parallel bundle of beams.

Should this bundle of beams be visualized as consisting of many partial beams, with a conventional photoelectric barrier with which the diversion takes place via two mirrors and the second path runs upwards, for example, opposite to the first path, the partial beam at the top of the transmitted bundle of beams is found at the bottom of the bundle following the diversion by the two mirrors onto the second path. Analogically, the partial beam at the bottom of the transmitted bundle of beams is found at the top following the diversion along the second path by two mirrors in the bundle. Should an object be found in the beam path in this exemplary arrangement which only blocks the upper part of the transmitted bundle of beams along the first path and the lower part of the bundle along the second path, it blocks the same partial beams twice, as the partial beams at the top of the light beam along the first path are found at the bottom of the second path in the bundle of beams. As a consequence, the loss of intensity on the reception device only corresponds to the loss caused by an object that is half the size of the actual object located in the beam path. As a result of this insight, it is the invention to design the diverter in such a way that the reflection of the beam takes place in such a way that the beam's constellation is retained. In the exemplary arrangement described, this means that an imagined partial light beam found at the top of the bundle of beams along the first path is also found at the top of the bundle along the second path following the diversion. This ensures that an object located in the beam path in the way described blocks different partial light beams in the bundle of beams along the first path than in the bundle along the second path. The loss of intensity detected on the reception device thus always corresponds to that of an object of the actual size of the object, independent of where the object is located in the beam path. As a result, the detection trigger is improved, particularly between the bundle of beams along the first path and the bundle of beams along the second path upon which the object blocks partial beams from both bundles.

The first path and the second path preferably run between a first side and a second side of an area to be monitored, and the transmission device and reception device are located on the first side. This enables a particularly simple constructive arrangement of the photoelectric barrier, as only the diverter must be provided on the second side, where neither the transmission device nor the reception device are located. Electric control elements, which control the transmission of an electromagnetic beam by the transmission device or the processing of signals from the reception device, that may have to be provided can be arranged on the first side and must not be placed far away from each other. In this way, it is especially possible to simply increase the fork width of the photoelectric barrier, i.e. the distance between the transmission device and the diverter, without having to take cables perhaps laid along the length into account. The photoelectric barrier preferably comprises several identical diverters. In this way, it is possible to guide the transmitted electromagnetic beam not only twice across the area to be monitored, but to allow it to run across several times. This further increases the size of the monitored area.

It is beneficial if the photoelectric barrier comprises at least one optical component that shapes the beams, such as a lens. With the aid of this component, the electromagnetic beam transmitted by the transmission device is transferred to a parallel light beam. The optics that shape the beams is preferably designed in such a way that as much radiated power from the transmission device as possible is transferred to the parallel light beam, i.e. in the monitored area. It is also desirable that the optics that shape the beam create an even distribution of the radiation intensity in the collimated bundle of beams, so that an object in the monitored area leads to the same loss of intensity on the reception device, independent of its position in the beam path.

The photoelectric barrier can possess at least one optical fiber, for example in the form of an optical fiber with a laser to fiber coupler and a fiber output coupler. An embodiment with optical fibers can be practical for constructing defined bundle cross-sections in the monitored area from several separate partial bundles, with the aid of optical fibers. In this case, the optical fibers in the diverter ensure the diversion of the individual partial bundles in the correct direction relative to each other.

The diverter may also have at least one mirrored surface. In particular, the diverter of the photoelectric barrier may comprise a diversion prism for diverting an electromagnetic beam in the correct direction at an angle of 180°. This type of diversion prism is a five-sided prism with, for example, three mirrored sides which create the reflection. As a result of this special arrangement of the surfaces to each other, a diversion in the correct direction occurs when using a diversion prism of this type.

The first path and the second path of a photoelectric barrier according to the invention are preferably arranged in such a way that the transmitted electromagnetic beam and the diverted electromagnetic beam run directly next to each other. This means that there is ideally no space between the bundle of beams moving along the first path and the bundle of beams moving along the second path, so that the two areas monitored by the two bundles merge seamlessly into each other. This ensures that there are no gaps through which an item could move without triggering the photoelectric barrier.

With the aid of a drawing an embodiment of the present invention will be explained in more detail. What is shown is:

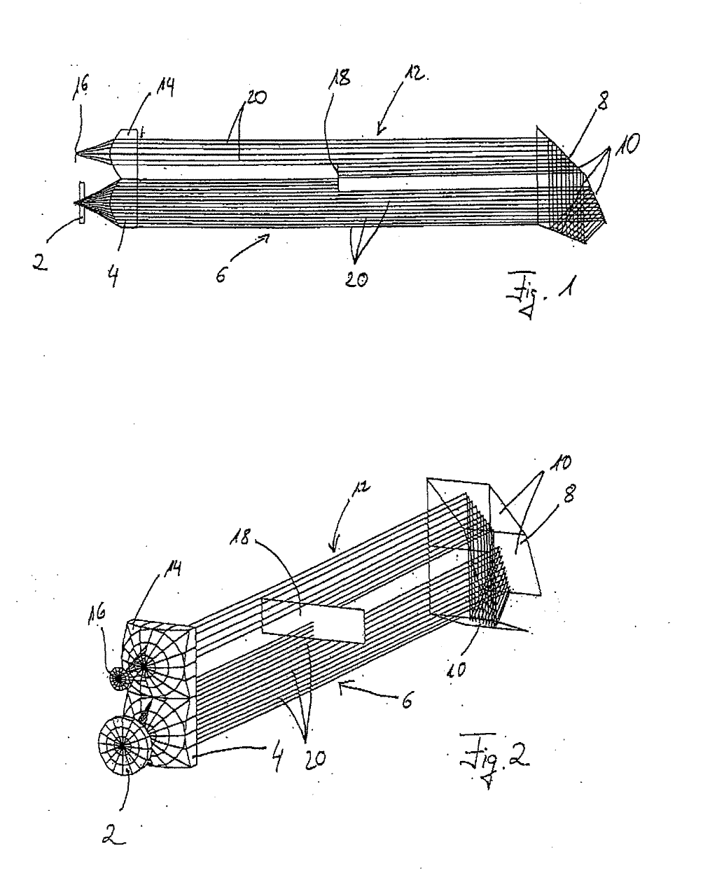

FIG. 1—the schematic depiction of the beam path in a photoelectric barrier according to an embodiment of the present invention,

FIG. 2—the schematic beam path in a photo electric barrier according to an embodiment of the present invention in a 3D view.

FIG. 1 shows the schematic beam path through a photoelectric barrier according to an embodiment of the present invention. A transmission device 2 sends electromagnetic radiation in the form of an expanding bundle of beams. This bundle of beams is transformed into a parallel bundle of beams by a lens 4. This is now transmitted along a first path 6 in the direction of a diverter: in the embodiment shown in FIG. 2, this is designed in the form of a diversion prism 8 for diverting an electromagnetic beam in the correct direction by 180°.

Within the diversion prism 8, the bundle of beams is reflected on three mirrored surfaces. This ensures a diversion of the incoming light beam so that the beam's constellation is preserved. The light beam comprises the diversion prism 8 for diverting an electromagnetic beam in the correct direction via the same surface through which it entered the diversion prism 8. It is then guided once more on a second path 12, shown in the embodiment in FIG. 1 as running parallel to the first path 6, across the area to be monitored.

At the end, the bundle of beams reaches a second lens 14 through which it is projected onto a reception device 16, which may be in the form of a photodiode, for example.

In the embodiment shown in FIG. 1, there is an object 18 located in the beam path. It is located in the beam path in such a way that it blocks part of the bundle of beams on the first path 6 and part of the bundle of beams on the second path 12. In FIG. 1 the bundle of beams is depicted as a number of imagined individual beams 20. It is clear to see that the individual beams 20 from the bundle of beams along the first path 6, as well as from the bundle along the second path 12, terminate at the object 18.

Due to the diversion of the bundle of beams in the correct direction within the diversion prism 8 to the diversion of an electromagnetic beam in the correct direction by 180°, the object 18 blocks exactly the same number of individual beams 20 as when the object 18 is located entirely in the in the bundle of beams along the first path 6 or the second path 12. The loss of intensity detected on the reception device 16 is therefore independent of from the position of the object 18 in the beam path of the photoelectric barrier. Consequently, the sensitivity of the photoelectric barrier is also independent from the position of the object 18.

FIG. 2 shows the same arrangement as in FIG. 1 in a schematic 3D view. Once again, an expanding bundle of beams is sent out by the transmitting device 2, which is converted into a parallel bundle of beams by a first lens 4. This type of lens 4 can be a collimator lens, for example. However, microlens arrays, fresnel lenses or diffractive elements such as holograms are also suitable. Furthermore, in FIG. 2, this bundle of beams is depicted in the form of a number of imagined individual beams 20, shown as individual lines. On the way from the first lens 4 to a diversion prism 8, in which the bundle of beams is diverted onto the three mirrored surfaces 10, some of the individual beams 20 hit an object 18 located in the beam path, where they are absorbed.

Once the bundle of beams has been diverted in the correct direction within the diversion prism 8, the bundle of beams is guided out of the remaining individual beams 20 along the second path 12 to the second lens 14, which projects the bundle of beams onto the reception device 16. In this way, some of the individual beams 20 again hit the object 18 and are absorbed here.

In FIG. 1, as well as in FIG. 2, it can be recognized that the individual beams 20 that are located along the first path 6 in the lower part of the bundle of beams are also found along the second path 12 in the lower part of the bundle. As a result, the object 18 in the first path 6 and the second path 12 can absorb various individual beams 20 and thus lead to a loss of intensity on the reception device 16. This corresponds to the loss of intensity that the object 18 would cause if it were located entirely in the bundle of beams along the first path 6 or entirely in the bundle of beams along the second path 12.

Therefore it is only crucial that a diversion that preserves the beam's constellation or constellation of its partial beams, relative to the plane containing the first path and the second path occurs inside the diverter, which is designed in FIGS. 1 and 2 as a diversion prism that diverts the beam of electromagnetic radiation by 180° preserving the beam's constellation. In the embodiment shown in FIGS. 1 and 2, this means that the individual beams 20, located along the first path 6 in the lower part of the bundle of beams, are also found along the second path 12 in the lower part of the bundle of beams following the diversion by the diversion prism 8.

### REFERENCE NUMERALS LIST

2 Transmission device
4 First lens
6 First path
8 Diversion prism
10 Mirrored surface
12 Second path
14 Second lens
16 Reception device
18 Object
20 Individual beam

1. A photoelectric barrier with a transmission device for the transmission of a beam of electromagnetic radiation along a first path, a diverter for diverting the transmitted beam of electromagnetic radiation from the first path onto a second path, and a reception device for receiving the beam of electromagnetic radiation, wherein the diverter is designed for a diversion that retains the beam's constellation relative to a plane containing the first path and the second path.

2. The photoelectric barrier according to claim 1, wherein the beam of electromagnetic radiation is a bundle of beams.

3. The photoelectric barrier according to claim 1, wherein the photoelectric barrier comprises several of the same type of diverter.

4. The photoelectric barrier according to claim 1, wherein the first path and the second path run between a first side and a second side of an area to be monitored, and the transmission device and reception device are located on the first side.

5. The photoelectric barrier according to claim 1, Wherein the photoelectric barrier comprises optics, which shape the beam.

6. The photoelectric barrier according to claim 1, wherein the transmission device comprises a number of light sources.

7. The photoelectric barrier according to claim 1, Wherein the diverter comprises at least one optical fiber for diverting an electromagnetic beam.

8. The photoelectric barrier according to claim 1, wherein the diverter comprises at least one mirrored surface

9. The photoelectric barrier according to claim 1, wherein the diverter comprises a diversion prism for diverting a beam of electromagnetic radiation at an angle of 180° retaining its constellation.

10. The photoelectric barrier according to claim 1, wherein the first path and the second path are arranged in such a way that the transmitted electromagnetic beam and the diverted electromagnetic beam run directly next to each other.
